(19) United States
(12) Patent Application Publication
(10) Pub. No.: US 2025/0004215 A1
(43) Pub. Date: Jan. 2, 2025

(54) TECHNOLOGIES FOR A HYBRID OPTICAL CHIP-TO-CHIP COUPLING

(71) Applicant: Intel Corporation, Santa Clara, CA (US)

(72) Inventor: Nicholas D. Psaila, Lanark (GB)

(73) Assignee: Intel Corporation, Santa Clara, CA (US)

(21) Appl. No.: 18/342,422

(22) Filed: Jun. 27, 2023

(51) Int. Cl. G02B 6/42; G02B 6/02

(52) U.S. Cl. CPC G02B 6/4214; G02B 6/02033; G02B 6/02061; G02B 6/02395; G02B 6/4206

(57) ABSTRACT

Technologies for hybrid optical chip-to-chip coupling are disclosed. In an illustrative embodiment, light from a waveguide in a photonic integrated circuit (PIC) die is collimated using a micromirror and directed towards a glass substrate. Another micromirror in the glass substrate focuses the light into a waveguide defined in a bulk layer of the glass substrate. In the illustrative embodiment, the waveguide is directly written into the bulk layer using an ultrafast laser. The glass substrate also has waveguides with a large difference in the index of refraction in a layer above the bulk substrate, such as silicon nitride waveguides in silicon oxide cladding. The directly-written waveguides can be evanescently coupled to the silicon nitride waveguides. The silicon nitride waveguides can then be used for two-dimensional routing throughout the glass substrate. The light can be coupled back into a directly-written waveguide before it is transmitted to another PIC die.

### BACKGROUND

Photonic integrated circuits (PICs) dies can be used for several applications, such as communications. PIC dies can offer high-speed, compact communication. However, PIC dies have drawbacks in certain situations, such as communicating across a large package. In a multi-die package, a silicon photonic waveguide routed across tens of millimeters may incur substantial signal loss and may be prohibitively expensive. Other optical communication options at the package level have drawbacks as well. Optical fibers can route between dies with low loss, but incorporating optical fibers at the package level suffers from integration and handling challenges. Polymer waveguides suffer from high loss, reliability issues, and integration issues such as poor resilience to high temperatures. Some approaches, such as glass-based ion-exchange waveguides and direct-write waveguides, can offer low-loss propagation but suffer from density restrictions due to limited refractive index contrast. Forming waveguides such as silicon nitride waveguides on a glass substrate can offer low-loss propagation and high density, but low-loss coupling to such waveguides from a PIC die can be difficult.

### BRIEF DESCRIPTION OF THE DRAWINGS

FIG. 1 is an isometric view of a system including an integrated circuit package with a glass substrate, a photonic integrated circuit (PIC) die, and an electrical integrated circuit (EIC) die.

FIG. 2 is a top-down view of the system of FIG. 1.

FIG. 3 is a cross-sectional view of one embodiment of the system of FIG. 1.

FIG. 4 is a cross-sectional view of one embodiment of the system of FIG. 1.

FIG. 5 is a cross-sectional view of one embodiment of the system of FIG. 1.

FIG. 6 is a cross-sectional view of one embodiment of the system of FIG. 1.

FIG. 7 is a cross-sectional view of one embodiment of the system of FIG. 1.

FIG. 8 is a cross-sectional view of one embodiment of the system of FIG. 1.

FIG. 9 is a cross-sectional view of one embodiment of the system of FIG. 1.

FIG. 10 is a top-down view of one embodiment of the system of FIG. 1.

FIGS. 11 and 12 are a simplified flow diagram of at least one embodiment of a method for manufacturing a system including a glass substrate with a PIC die and an EIC die mounted on it.

FIG. 13 is a top view of a wafer and dies that may be included in a microelectronic assembly, in accordance with any of the embodiments disclosed herein.

FIG. 14 is a cross-sectional side view of an integrated circuit device that may be included in a microelectronic assembly, in accordance with any of the embodiments disclosed herein.

FIGS. 15A-15D are perspective views of example planar, gate-all-around, and stacked gate-all-around transistors.

FIG. 16 is a cross-sectional side view of an integrated circuit device assembly that may include a microelectronic assembly, in accordance with any of the embodiments disclosed herein.

FIG. 17 is a block diagram of an example electrical device that may include a microelectronic assembly, in accordance with any of the embodiments disclosed herein.

### DETAILED DESCRIPTION

In various embodiments disclosed herein, a glass substrate can be created with one or more low-index-difference direct-write waveguides and one or more high-index-difference waveguides, such as silicon nitride waveguides, formed on the surface of the glass substrate. The direct-write waveguides offer relatively low sensitivity to misalignment and flexible 3D routing. The silicon nitride waveguides offer low-loss, dense routing of waveguides on the substrate. The direct-write waveguides can be used for coupling on and off of the glass substrate, and the silicon nitride waveguide can be used to carry signals across the glass substrate. Such a glass substrate can be integrated into a package with other components, such as photonic integrated circuit (PIC) dies and electrical integrated circuit (EIC) dies. Waveguides in the glass substrate can be coupled to waveguides in the PIC dies in various ways, as discussed in more detail below.

As used herein, the phrase “communicatively coupled” refers to the ability of a component to send a signal to or receive a signal from another component. The signal can be any type of signal, such as an input signal, an output signal, or a power signal. A component can send or receive a signal to another component to which it is communicatively coupled via a wired or wireless communication medium (e.g., conductive traces, conductive contacts, air). Examples of components that are communicatively coupled include integrated circuit dies located in the same package that communicate via an embedded bridge in a package substrate and an integrated circuit component attached to a printed circuit board that send signals to or receives signals from other integrated circuit components or electronic devices attached to the printed circuit board.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact, and “coupled” may indicate elements co-operate or interact, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, the central axis of a magnetic plug that is substantially coaxially aligned with a through hole may be misaligned from a central axis of the through hole by several degrees. In another example, a substrate assembly feature, such as a through width, that is described as having substantially a listed dimension can vary within a few percent of the listed dimension.

It will be understood that in the examples shown and described further below, the figures may not be drawn to scale and may not include all possible layers and/or circuit components. In addition, it will be understood that although certain figures illustrate transistor designs with source/drain regions, electrodes, etc. having orthogonal (e.g., perpendicular) boundaries, embodiments herein may implement such boundaries in a substantially orthogonal manner (e.g., within +/−5 or 10 degrees of orthogonality) due to fabrication methods used to create such devices or for other reasons.

Reference is now made to the drawings, which are not necessarily drawn to scale, wherein similar or same numbers may be used to designate the same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

As used herein, the phrase “located on” in the context of a first layer or component located on a second layer or component refers to the first layer or component being directly physically attached to the second part or component (no layers or components between the first and second layers or components) or physically attached to the second layer or component with one or more intervening layers or components.

As used herein, the term “adjacent” refers to layers or components that are in physical contact with each other. That is, there is no layer or component between the stated adjacent layers or components. For example, a layer X that is adjacent to a layer Y refers to a layer that is in physical contact with layer Y.

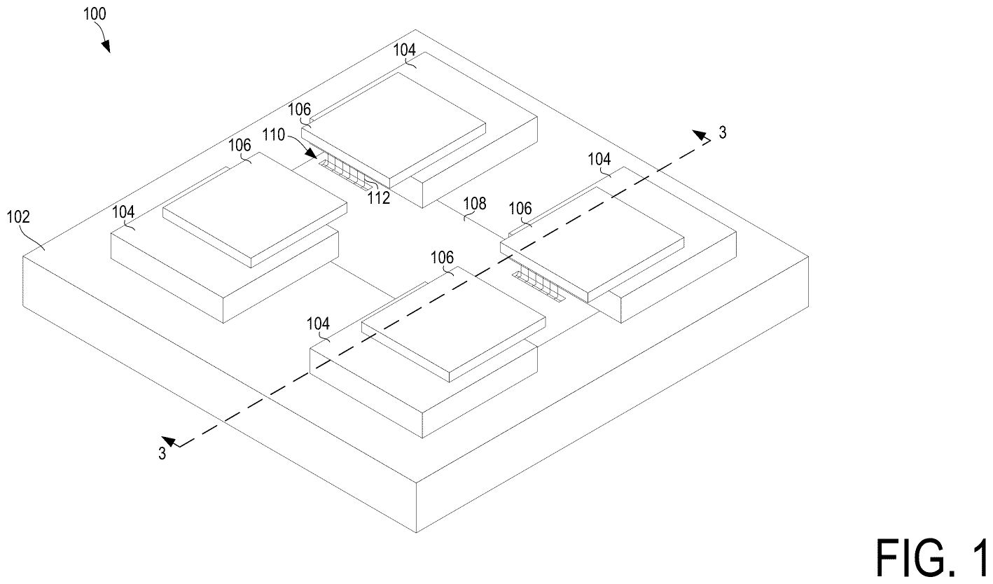

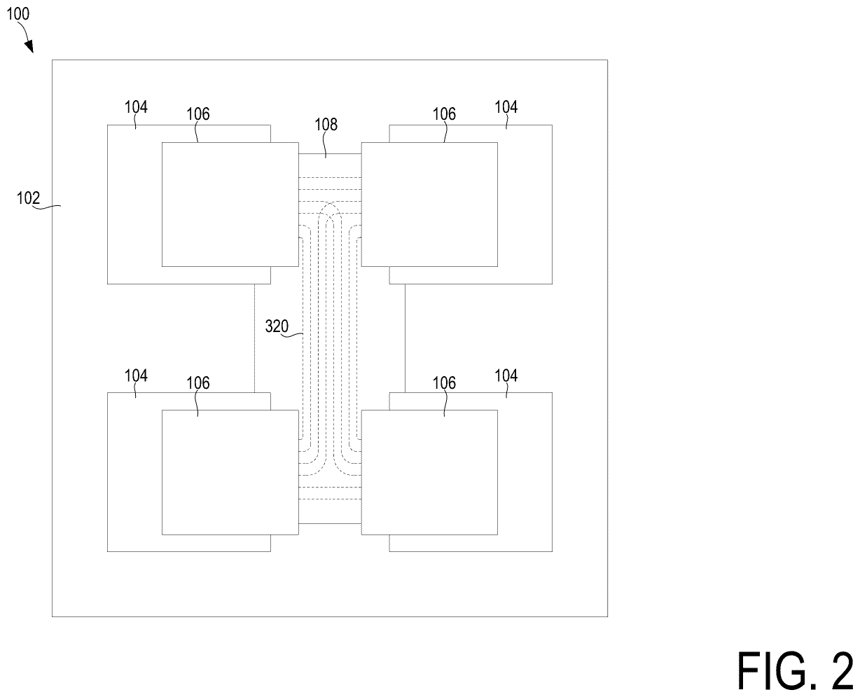

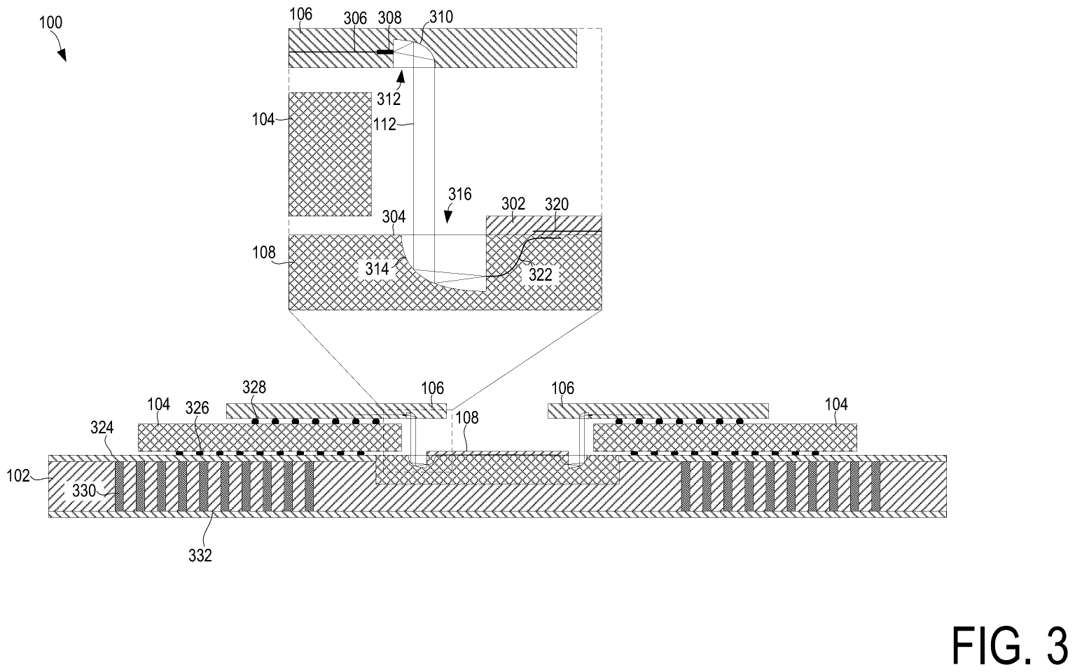

Referring now to FIGS. 1-3, in one embodiment, an integrated circuit package 100 includes a substrate 102, one or more EIC dies 104, one or more PIC dies 106, and a glass substrate 108. FIG. 1 shows a perspective view of the integrated circuit package 100, FIG. 2 shows a top-down view of the integrated circuit package 100, and FIG. 3 shows a cross-sectional view of one embodiment of the integrated circuit package 100.

In the illustrative embodiment, EIC dies 104 are mounted on the substrate 102, and PIC dies 106 are mounted on the EIC dies 104. The PIC dies 106 have one or more waveguides 306 in them. Light from the waveguides 306 can be coupled out of the PIC dies 106 through couplers 308. The light can be collimated and reflected towards the glass substrate 108 by micromirrors 310 in a recess 312 of the PIC die 106. The micromirrors 310 collimate the light into beams 112. The beams 112 are focused and reflected towards waveguides 322 in the glass substrate 108. The light is coupled into the waveguides 322, which are routed within the glass substrate 108. The waveguides 322 may have any suitable diameter, such as 2-20 micrometers. The waveguides 320 may have any suitable diameter, such as 0.2-5 micrometers. The diameter of each waveguide 320, 322 may be limited by the particular physical factors of an embodiment, such as wavelength, difference in index of refraction between the core and cladding, acceptable guiding/bending loss, etc.

In the illustrative embodiment, the waveguides 322 are evanescently coupled to waveguides 320. To evanescently couple, the center of the waveguides 322 may be within 0-20 micrometers from the center of waveguides 320. The waveguides 322, 320 may co-propagate for any suitable distance, such as 100 micrometers to 10 millimeters. After the region wherein the waveguides 320 evanescently couple with the waveguides 322, the waveguides 320 are routed throughout the glass substrate. Each waveguide 320 can be coupled to another waveguide 322 at the other end, allowing the light to be coupled to another waveguide 306 in another PIC die 106 in a similar manner.

In the illustrative embodiment, the waveguides 322 are direct-write waveguides that are directly written in the bulk layer 304 of the glass substrate 108, such as by using an ultrafast laser to slightly change an index of refraction of the glass substrate 108. The waveguides 322 have a relatively small difference in the index of refraction between the core and the cladding, such as less than 0.05-0.001. The illustrative waveguides 320 are formed on top of the glass substrate 108, such as by lithographically depositing, e.g., silicon nitride waveguides 320. The waveguides 320 are surrounded by a cladding layer 302 on some or all of their sides. The waveguides 320 have a relatively large difference in the index of refraction between the core and the cladding, such as more than 0.05-0.1. The waveguides 320 may be directly adjacent the bulk layer 304 of the glass substrate 108 or the waveguides 320 may be fully surrounded by the cladding layer 302. The waveguides 320 may be any suitable material, such as silicon nitride, silicon oxynitride, indium phosphide, aluminum nitride, lithium niobate, chalcogenide, silicon carbide, etc. The cladding layer 302 for the waveguides 320 may be any suitable material, such as silicon oxide. In some embodiments, the cladding layer 302 may be any of the types of materials as the glass substrate 108 described below. In the illustrative embodiment, the cladding layer 302 is deposited over the waveguides 320 after the waveguides are deposited over the bulk layer 304 of the glass substrate 108. The waveguides 320 may have low propagation loss, such as less than 0.01 dB per centimeter.

The waveguides 322, 320 may be routed in the glass substrate 108 in any suitable manner, including in three dimensions, allowing for flexible layouts. In some embodiments, the waveguides 322 can be easily routed in three dimensions while the waveguides 320 are only routed in two dimensions. The glass substrate 108 may include optical elements such as fan outs, splitters, couplers, combiners, filters, etc.

The light in the waveguides 306, 322, 320 may be any suitable wavelength, such as 400-2,000 nanometers. In the illustrative embodiment, the light in the waveguides 306, 322, 320 is, e.g., 1,200-1,600 nanometers. The mirror 310 may collimate the light to a beam 112 of any suitable diameter, such as 20-500 micrometers, as measured at the 1/e² width. The mirror 310 may have any suitable shape, such as an off-axis parabola, a toroidal surface, an aspherical surface, etc. In some embodiments, the mirrors 310 may be arranged in two-dimensional arrays to increase channel density. Light in the waveguides 306, 322, 320 may travel from the PIC die 106 to the glass substrate 108 and/or from the glass substrate 108 to the PIC die 106.

The curved micromirrors 310, 314 may be formed from the substrate of the PIC die 106 and glass substrate 108, respectively, or one or both of the micromirrors 310, 314 may be embodied as an insert is positioned at least partially inside of a cavity defined in the PIC die 106 or glass substrate 108, respectively. The curved micromirrors 310, 314 may include a coating to reflect light, such as a reflective metal such as aluminum, silver, gold, etc. In some embodiments, the curved micromirrors 310, 314 may include a dielectric stack. In other embodiments, the curved micromirrors 310, 314 may operate based on total internal reflection. In some embodiments, the shape of the micromirror 314 may be formed by selective laser etching to remove a section from the glass substrate 108. After the reflective surface of the mirror 310 is applied, the section may be backfilled with any suitable material, allowing for planarization of the glass substrate 108. In the illustrative embodiment, the mirrors 310 direct the beams 112 out of the PIC die 106 at approximately normal incidence. In other embodiments, the geometry of the mirrors 310, 314 may be tailored to control the angle of the beam 112 emerging from the PIC die 106, which may mitigate backreflections or may be used to control incident angles for achieving total internal reflection. In some embodiments, polarization filtering could also be achieved by appropriate geometries to make use of Brewster angles of incidence on the reflecting surfaces.

It should be appreciated that, as the diameter of the collimated beam 112 is significantly larger than the diameter of the beam in the waveguide 306 or waveguide 322, the alignment of the PIC die 106 to the glass substrate 108 is less sensitive than for, e.g., direct coupling between waveguides.

The illustrative glass substrate 108 is silicon oxide glass. In other embodiments, the substrate 108 may be made of any suitable material that may be crystalline, non-crystalline, amorphous, etc., such as fused silicon, borosilicate, sapphire, yttrium aluminum garnet, etc. The glass substrate 108 may be, e.g., aluminosilicate glass, borosilicate glass, alumino-borosilicate glass, silica, fused silica. The glass substrate 108 may include one or more additives, such as Al2O3, B2O3, MgO, CaO, SrO, BaO, SnO2, Na2O, K2O, SrO, P2O3, ZrO2, Li2O, Ti, and Zn. The glass substrate 108 may comprise silicon and oxygen, as well as any one or more of aluminum, boron, magnesium, calcium, barium, tin, sodium, potassium, strontium, phosphorus, zirconium, lithium, titanium, and zinc. The glass substrate 108 may include at least 20-40 percent silicon by weight, at least 20-40 percent oxygen by weight, and at least 5 percent aluminum by weight. For example, some embodiments of the glass substrate 108 may include, e.g., at least 20-23 percent silicon and at least 20-26 percent oxygen by weight.

The glass substrate 108 may have any suitable length or width, such as 3-500 millimeters. The glass substrate 108 may have any suitable thickness, such as 0.2-5 millimeters. The glass substrate 108 may include any suitable number of waveguides 322, 320, such as 1-1,024 waveguides 322, 320 for each PIC die 106.

The PIC die 106 may be made of any suitable material, such as silicon. In the illustrative embodiment, the waveguides 306 may be silicon waveguides embedded in silicon oxide cladding. The PIC die 106 may include any suitable number of waveguides 306, such as 1-1,024. In the illustrative embodiment, the waveguides 306 in the PIC die 106 are edge-coupled waveguides 306. In other embodiments, the waveguides 306 may be vertically coupled out of the PIC die 106.

The PIC die 106 is configured to generate, detect, and/or manipulate light. The PIC die 106 may include active or passive optical elements such as splitters, couplers, filters, optical amplifiers, lasers, photodetectors, modulators, routers, etc.

The EIC die 104 may include any suitable electronic integrated circuit component, such as resistors, capacitors, inductors, transistors, etc. The EIC die 104 may include any suitable analog and/or digital circuitry, such as a processor, a memory, an application-specific integrated circuit (ASIC), a field-programmable gate array (FPGA), etc. The EIC die 104 may be embodied as an xPU, such as a central processing unit or a graphics processing unit. In some embodiments, the integrated circuit package 100 may be embodied as a router, a switch, a network interface controller, and/or the like. In such embodiments, the EIC die 104 may include network interface controller circuitry to process, parse, route, etc., network packets sent and received by the integrated circuit package 100.

The PIC die 106 is connected to the EIC die 104 through one or more solder bumps 328. The solder bumps 328 may be used to transmit and receive signals from the EIC die 104 to the PIC die 106, provide power to the PIC die 106, etc.

The EIC die 104 is mounted on the substrate 102. The EIC die 104 is connected to the substrate 102 through one or more solder bumps 326. The solder bumps 326 may be used to transmit and receive signals between the EIC die 104 and the substrate 102, provide power to the EIC die 104, etc. The substrate 102 may provide various electrical connections. For example, the substrate 102 may include a redistribution layer 332 on the bottom of the substrate 102 and/or may include a redistribution layer 324 on the top of the substrate 102. Vias 330 filled with conductive material may provide electrical connections between the top and bottom surfaces of the substrate 102 (e.g., between the redistribution layer 332 and the redistribution layers 324).

The substrate 102 may be any suitable material, such as a ceramic substrate or an organic substrate. In some embodiments, the substrate 102 may be embodied as a printed circuit board made from ceramic, glass, and/or organic-based materials with fiberglass and resin, such as FR-4. The substrate 102 may have any suitable length or width, such as 10-500 millimeters. The substrate 102 may have any suitable thickness, such as 0.2-5 millimeters. The substrate 102 may support additional components besides the glass substrate 108, PIC dies 106, and EIC dies 104, such as additional photonic or electronic integrated circuit components, a processor unit, a memory device, an accelerator device, etc.

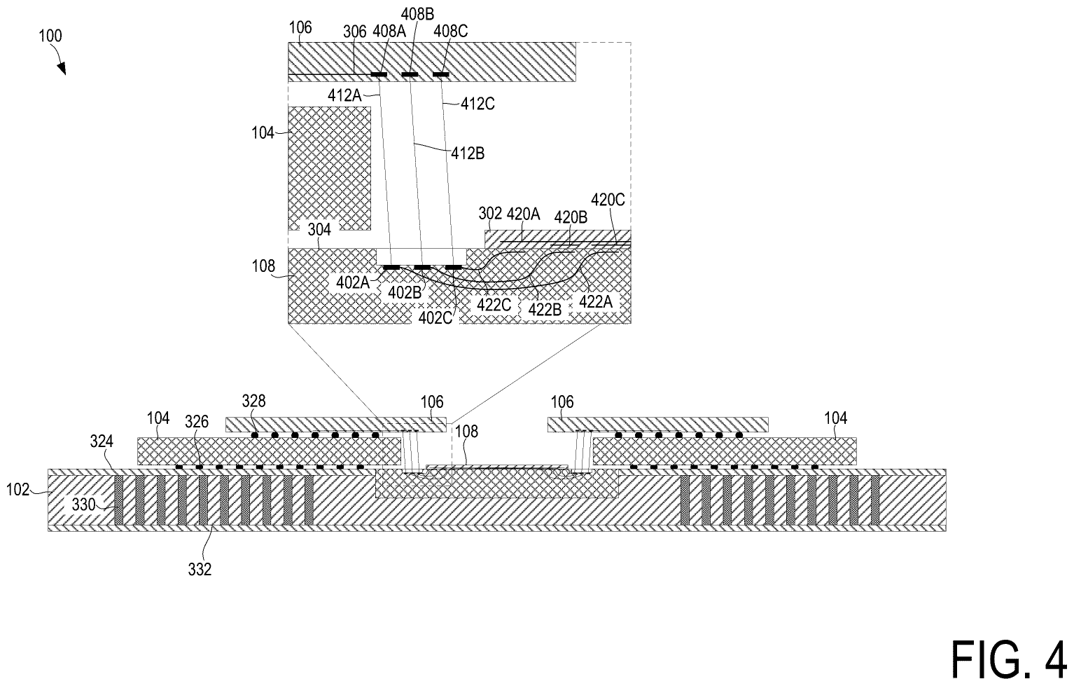

Referring now to FIG. 4, in one embodiment, a multirow interconnect interface may be used, allowing for 2D arrays of optical structures to be used, resulting in increased optical interconnect density. Waveguides 306 in the PIC die 106 may be connected to couplers 408A-408C in several rows, which sends the light to couplers 402A-402C in the glass substrate 108. An array of micromirrors, such as the micromirrors 310, 314 may be used to collimate light into beams 412A-412C between the PIC dies 106 and the glass substrate 108.

Additionally or alternatively to the multirow interconnect interface, the glass substrate 108 may include two or more layers of high-index-difference waveguides 420, as shown in FIG. 4. The different layers of waveguides 420 may have any suitable pitch, such as 1-5 micrometers. In the illustrative embodiment, the waveguides 422A-422C in the bulk layer 304 of the glass substrate 108 can evanescently couple to waveguides 420A-420C in higher layers. Additionally or alternatively, intermediate waveguides may be used to couple from the waveguides 422 to the waveguides 422, such as waveguides 420 in other layers or waveguides directly written into the cladding with, e.g., an ultrafast laser, which can then be routed in three dimensions. Any suitable number of layers of waveguides 420 may be present in the cladding, such as 1-10.

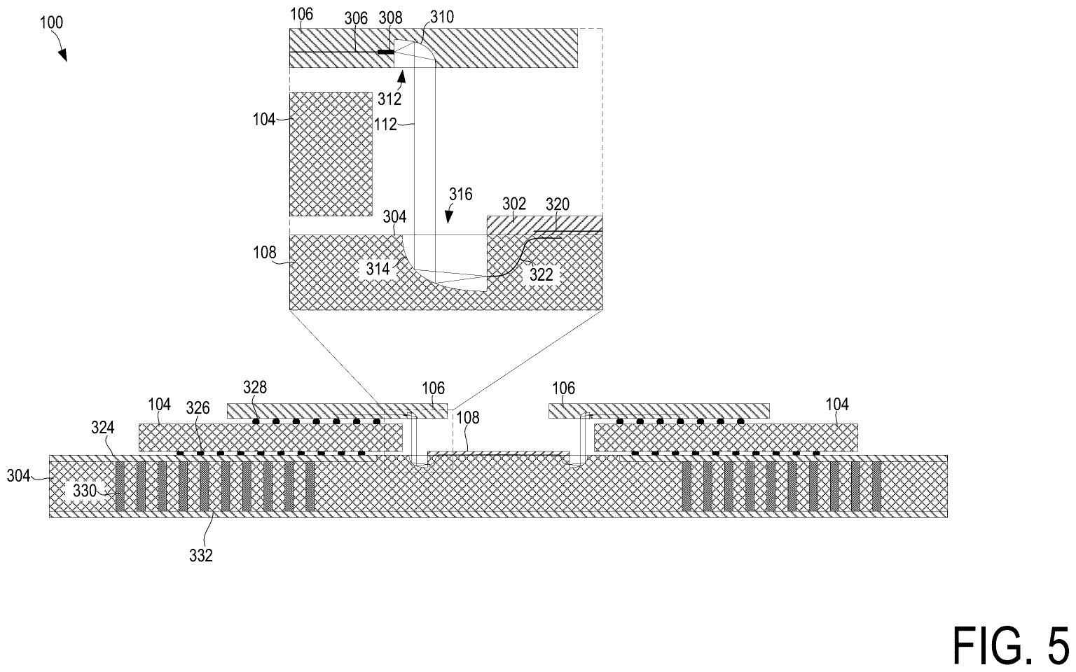

Referring now to FIG. 5, in one embodiment, the glass substrate 108 acts as an interposer in the integrated circuit package 100. The glass substrate 108 may have redistribution layer 324 on top of the bulk layer 304 and/or may have redistribution layer 332 on the bottom of the bulk layer 304. Through-glass vias 330 may provide electrical connections through the glass substrate 108. In such an embodiment, the glass substrate 108 may act as an embedded interconnect die.

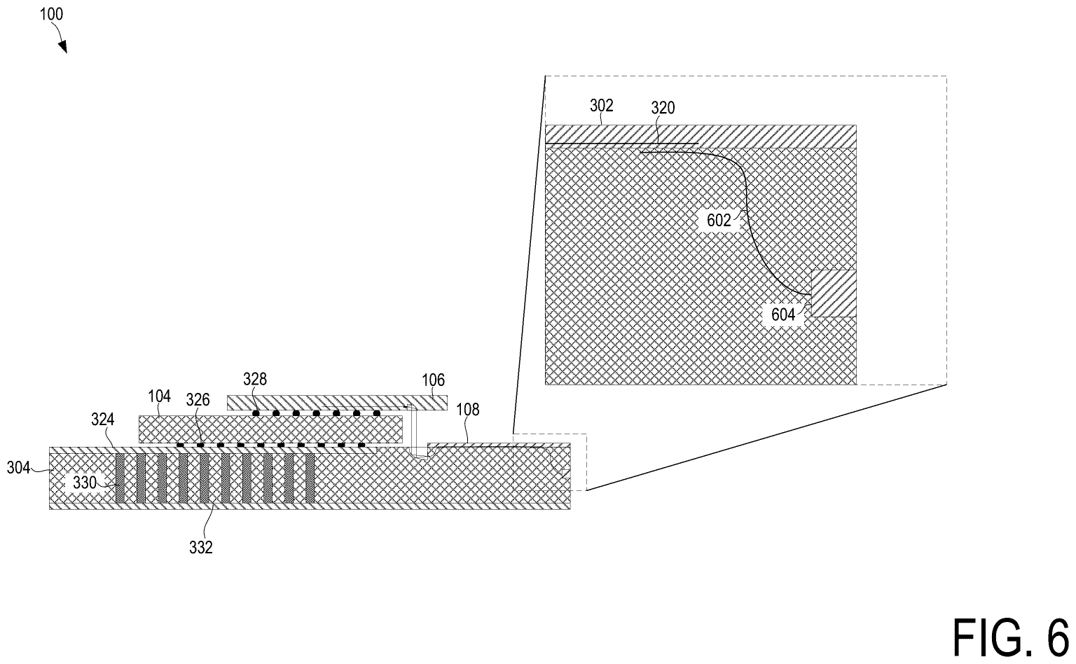

Referring now to FIG. 6, in some embodiments, a waveguide 602 in the bulk layer 304 may be routed to an optical connector 604 at an edge of the glass substrate 108. The waveguide 602 may be similar to the waveguides 322. The optical connector 604 may interface with an external optical fiber to transport the optical signal off of the integrated circuit package 100.

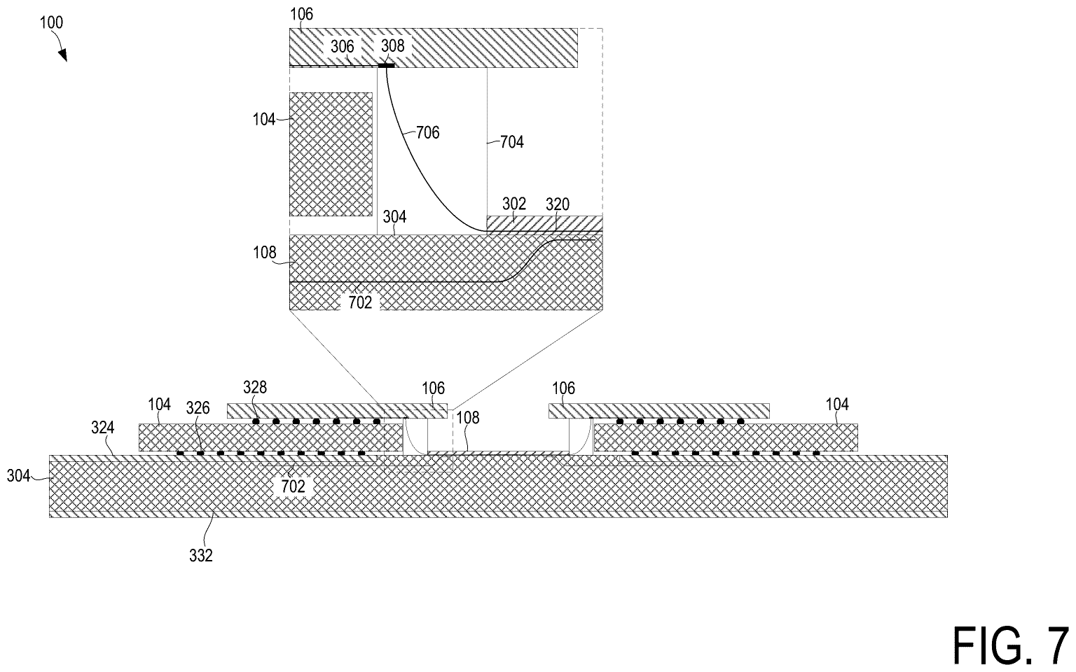

Referring now to FIG. 7, in some embodiments, a two-photon-polymerization (TPP) fabricated waveguide 706 and surrounding cladding 704 may be used to route signals between the PIC die 106 and the glass substrate 108. In some embodiments, the cladding 704 may be built up on top of the glass substrate, and the waveguide 706 may then be written in the cladding 704. The PIC die 106 can then be placed over the cladding structure 704.

Additionally or alternatively, in some embodiments, a waveguide 702 defined in the bulk layer 304 may be evanescently coupled to the waveguide 320. The waveguide 702 may extend, e.g., under the PIC die 106, under the EIC die 104, to waveguides 320 in other cladding layers 302 located in a different part of the glass substrate 108, etc.

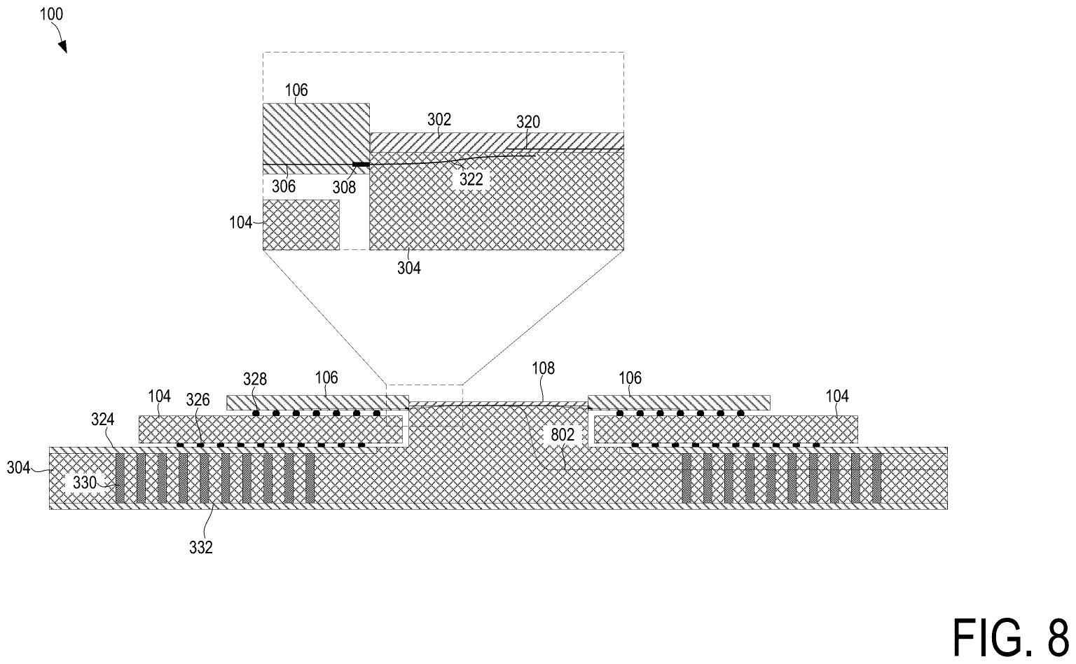

Referring now to FIG. 8, in some embodiments, the waveguides 306 in the PIC die 106 may be butt-coupled directly to the waveguides 322 in the glass substrate 108, as shown in the figure. In such embodiments, waveguides 802 in the glass substrate 108 may route signals in other parts of the glass substrate 108, such as below EIC dies 104.

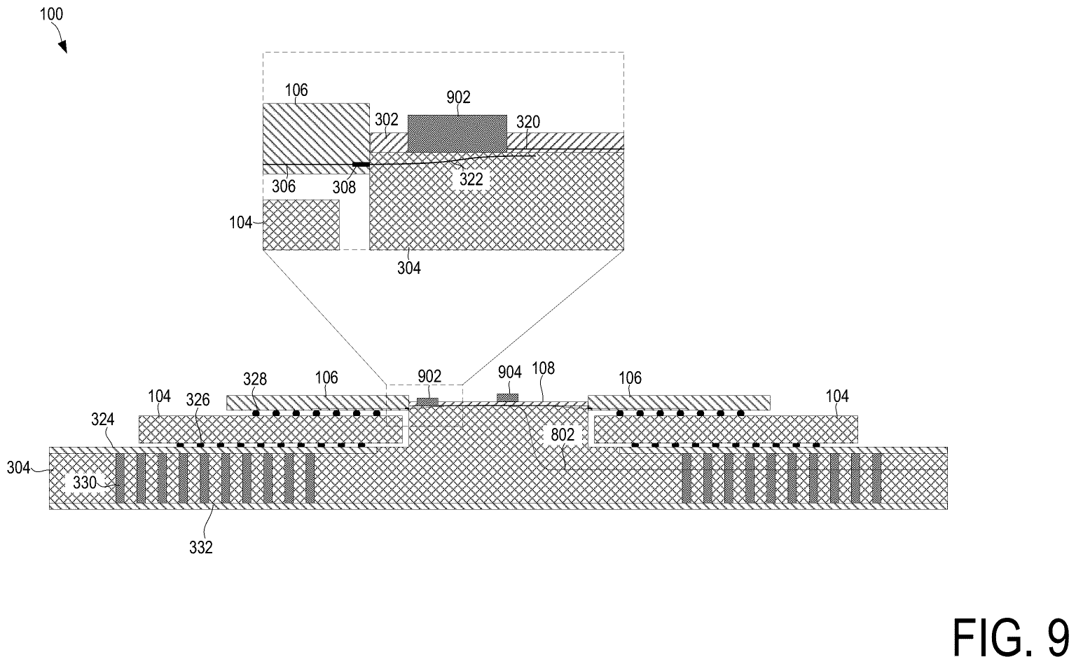

Referring now to FIG. 9, in some embodiments, additional passive and/or active optical components may be positioned on or in the glass substrate. For example, butt-coupled components 902 may butt-couple directly to waveguides 320. Additionally or alternatively, components 904 may be positioned to evanescently couple with the waveguides 320. The components 904 may be placed on top of the cladding layer 302 or may be placed in a recessed part of the cladding area 302, to be closer to the waveguides 320. The components 902, 904 may be embodied as or otherwise include, laser or other light sources, detectors, modulators, routing components, indium phosphide laser, another III-V semiconductor laser, a lithium niobate modulator, another silicon PIC die 106, etc. Additionally or alternatively, in some embodiments, thin-film modulators can be integrated onto the routing layer, such as thin-film lithium niobate or electro-optic polymers.

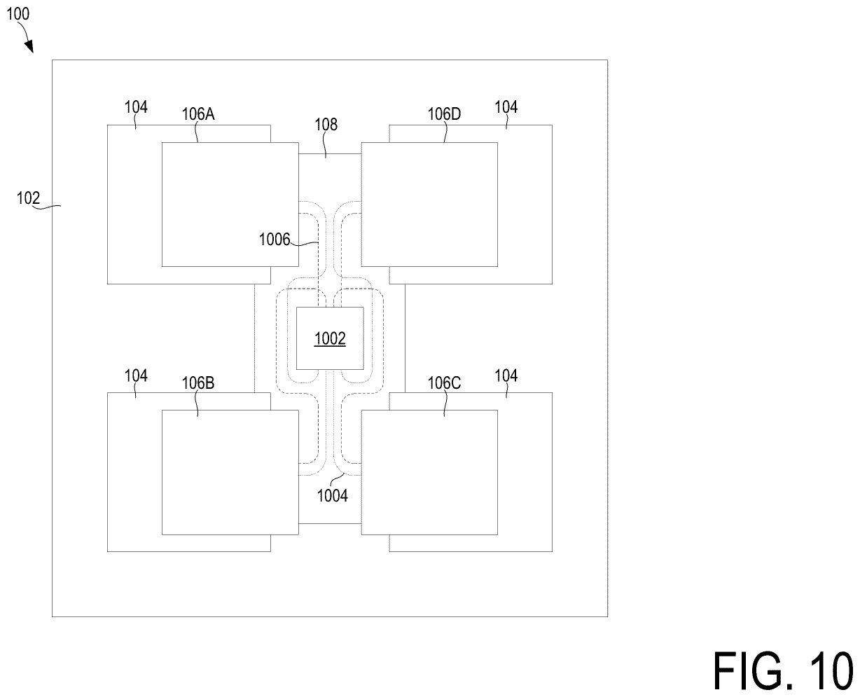

Referring now to FIG. 10, in some embodiments, a component such as a cyclical arrayed waveguide grating 1002 may be used to passively distribute signals to and from several PIC dies 106 using wavelength multiplexing. Each PIC die 106A-D may output several copies of the same signal at different wavelengths, such as λ₁, λ₂, λ₃, λ₄, to output waveguide 1004. For signals sent from PIC die 106A, the cyclical arrayed waveguide grating 1002 sends signal λ₁ to PIC die 106B, sends signal λ₂ to PIC die 106C, sends signal λ₃ to PIC die 106D, and sends signal λ₄ back to PIC die 106A. For signals sent from PIC die 106B, the cyclical arrayed waveguide grating 1002 sends signal λ₁ to PIC die 106C, sends signal λ₂ to PIC die 106D, sends signal λ₃ to PIC die 106A, and sends signal λ₄ back to PIC die 106B, and so on. In this manner, the signal from each PIC die 106 is distributed to every other PIC die 106, without any power or configuration required at the cyclical arrayed waveguide grating 1002. In the illustrative embodiment, the wavelength-multiplexed signals are demultiplexed at each PIC die 106, such as by using add/drop ring resonators. The signals from each of the other PIC dies 106 can then be processed separately.

In some embodiments, other routing or multiplexing approaches may be included in or on the glass substrate 108. For example, the glass substrate 108 may include or have mounted on it micro-ring modulators (which may be thermo-optic tuned), Mach-Zehnder interferometers, microelectromechanical (MEMs) optical switches, and/or nonlinear optical directional couplers.

It should be appreciated that the various features shown above in regard to FIGS. 3-10 may be used in any suitable combination with each other. For example, in some embodiments, the glass substrate 108 may include a multirow interconnect interface to interface with the PIC die 106, may include a off-package optical connector 604, and may include through-glass vias 330.

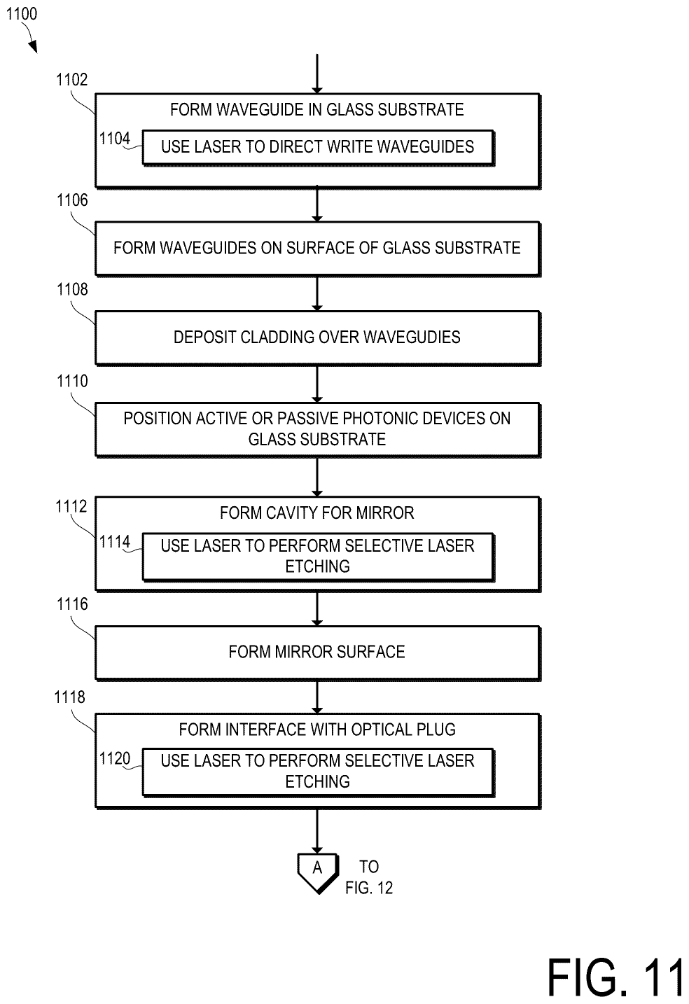

Referring now to FIG. 11, in one embodiment, a flowchart for a method 1100 for creating the integrated circuit package 100 with a glass substrate 108 and a PIC die 106 is shown. The method 1100 may be executed by a technician and/or by one or more automated machines. In some embodiments, one or more machines may be programmed to do some or all of the steps of the method 1100. Such a machine may include, e.g., a memory, a processor, data storage, etc. The memory and/or data storage may store instructions that, when executed by the machine, cause the machine to perform some or all of the steps of the method 1100. The method 1100 may use any suitable set of techniques that are used in semiconductor processing, such as chemical vapor deposition, atomic layer deposition, physical layer deposition, molecular beam epitaxy, layer transfer, photolithography, ion implantation, dry etching, wet etching, selective laser etching, thermal treatments, flip chip, layer transfer, magnetron sputter deposition, pulsed laser deposition, etc. In some embodiments, some or all steps of the method 1100 may be performed at the wafer level, the die level, and/or the package level, as appropriate. It should be appreciated that the method 1100 is merely one embodiment of a method to create one embodiment of the integrated circuit package 100, and other methods may be used to create any suitable embodiment of the integrated circuit package 100. In some embodiments, steps of the method 1100 may be performed in a different order than that shown in the flowchart.

The method 1000 begins in block 1102, in which one or more waveguides 322 are formed in the bulk layer 304 of the glass substrate 108. In the illustrative embodiment, the waveguides 322 are formed using a femtosecond laser to directly write the waveguides 322 in block 1104.

In block 1106, one or more waveguides 320 are formed on the surface of the glass substrate 108. For example, the material for the waveguides 320 may be deposited using, e.g., chemical vapor deposition, and the material other than the waveguides 320 may be removed using photolithographic techniques. In block 1108, a cladding layer 302 is deposited over the waveguides 320.

In block 1110, in some embodiments, active or passive photonic devices, such as components 902, 904 or cyclical arrayed waveguide grating 1002, may be positioned on the glass substrate 108.

In block 1112, a cavity is formed in the glass substrate 108 for the mirrors 314. In the illustrative embodiment, a femtosecond laser is used to perform selective laser etching in block 1114. A femtosecond laser is used to increase the susceptibility of part of the glass substrate 108 to etching, and then an etchant such as hydrofluoric acid etches away the treated portion of the glass. In block 1116, a reflective material such as silver, aluminum, or gold may be applied, or a reflective dielectric stack may be applied. The cavity may then be backfilled with any suitable material, allowing for planarization of the glass substrate 108.

In block 1118, in some embodiments, an interface for an optical plug 604 is formed. In block 1120, in the illustrative embodiment, a femtosecond laser is used to perform selective laser etching to create the interface for the optical plug 604.

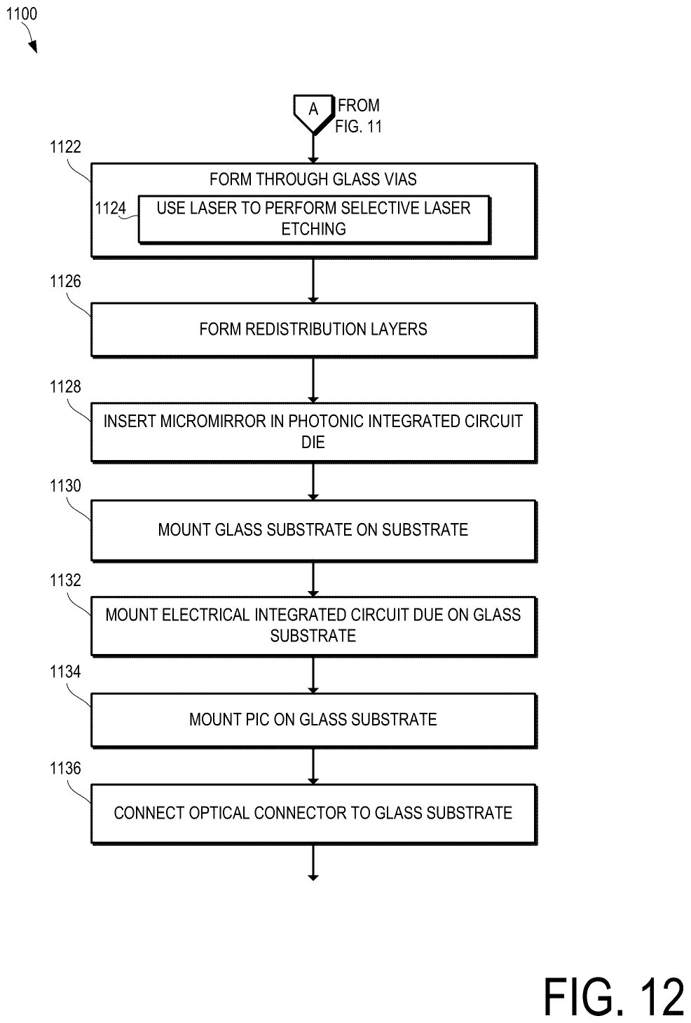

Referring now to FIG. 12, in block 1122, in some embodiments, through-glass vias 330 are formed in the glass substrate 108. Selective laser etching may again be used to form the through-glass vias 330 in block 1124. It should be appreciated that, in some embodiments, all of the steps involving selective glass etching may be performed with one etching step. The through-glass vias 330 may then be fully or partially filled with a conductive material, such as copper. In block 1126, redistribution layers 332, 324 may be formed on the top and/or bottom surface of the glass substrate 108.

In block 1128, an insert with the micromirrors 310 is inserted into a PIC die 106. The insert may be positioned using a pick and place machine. The insert may be fixed in place using, e.g., an adhesive. In some embodiments, an array of inserts may be positioned at the wafer level before the PIC dies 106 are singulated.

In block 1130, the glass substrate 108 is mounted on the substrate 102. In block 1132, the EIC die 104 is mounted on the substrate 102 or, in some embodiments, on the glass substrate 108. In the illustrative embodiment, the EIC die 104 is mounted by flipping the EIC die 104 over, and solder joints 326 are used to both mechanically and electrically couple the EIC die 104 to the substrate 102. In block 1134, a PIC die 106 is mounted on the EIC die 104 in a similar manner.

In block 1136, in some embodiments, an optical connector can be connected to the optical interface 604 in the glass substrate 108. It should be appreciated that the optical connector can be connected after other processing steps, such as solder reflow, that may otherwise damage the optical connector.

It should be appreciated that the glass substrate 108, without or with the substrate 102. PIC die 106, and/or the EIC die 104, may be integrated with other components, such as integrated into a multi-chip module alongside other chiplets or otherwise used as a host substrate for larger-scale assemblies.

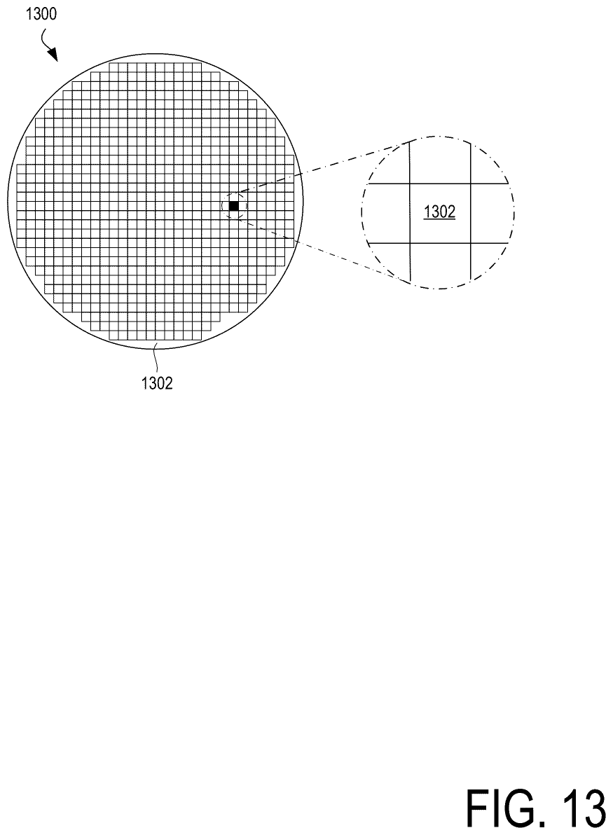

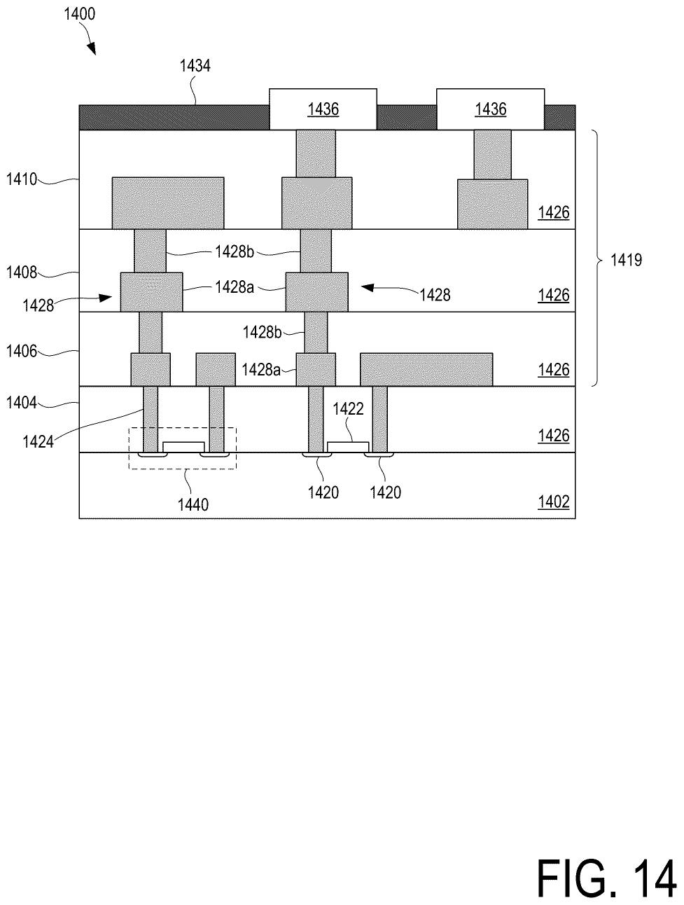

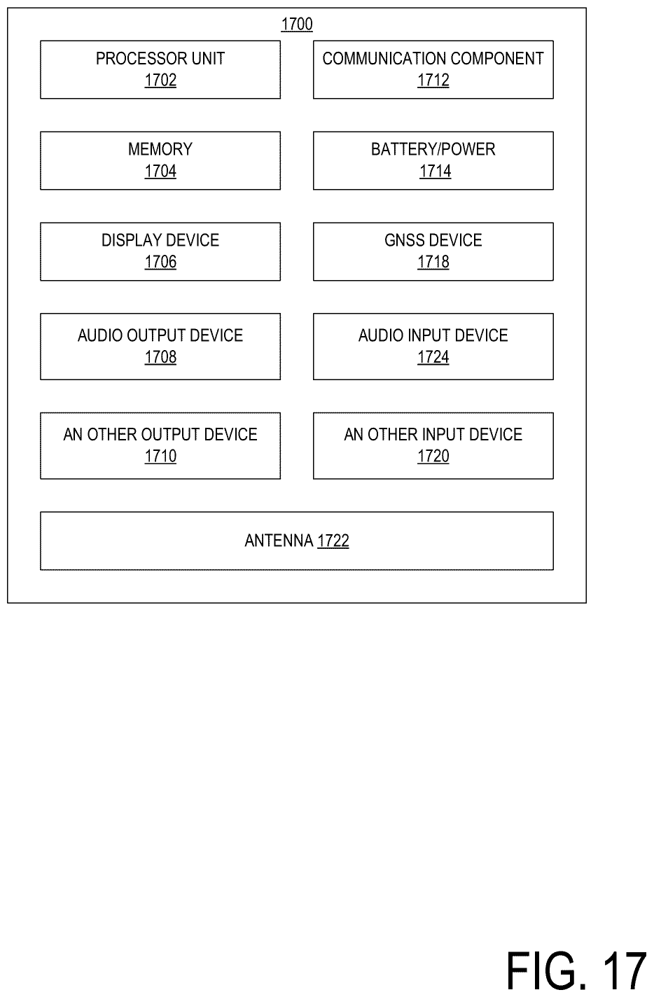

FIG. 13 is a top view of a wafer 1300 and dies 1302 that may be included in any of the integrated circuit packages 100 disclosed herein (e.g., as any suitable ones of the dies 104, 106). The wafer 1300 may be composed of semiconductor material and may include one or more dies 1302 having integrated circuit structures formed on a surface of the wafer 1300. The individual dies 1302 may be a repeating unit of an integrated circuit product that includes any suitable integrated circuit. After the fabrication of the semiconductor product is complete, the wafer 1300 may undergo a singulation process in which the dies 1302 are separated from one another to provide discrete “chips” of the integrated circuit product. The die 1302 may be any of the dies 104, 106 disclosed herein. The die 1302 may include one or more transistors (e.g., some of the transistors 1440 of FIG. 14, discussed below), supporting circuitry to route electrical signals to the transistors, passive components (e.g., signal traces, resistors, capacitors, or inductors), and/or any other integrated circuit components. In some embodiments, the wafer 1300 or the die 1302 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 1302. For example, a memory array formed by multiple memory devices may be formed on a same die 1302 as a processor unit (e.g., the processor unit 1702 of FIG. 17) or other logic that is configured to store information in the memory devices or execute instructions stored in the memory array. Various ones of the integrated circuit packages 100 disclosed herein may be manufactured using a die-to-wafer assembly technique in which some dies 104, 106 are attached to a wafer 1300 that include others of the dies 104, 106, and the wafer 1300 is subsequently singulated.

FIG. 14 is a cross-sectional side view of an integrated circuit device 1400 that may be included in any of the integrated circuit packages 100 disclosed herein (e.g., in any of the dies 104, 106). One or more of the integrated circuit devices 1400 may be included in one or more dies 1302 (FIG. 13). The integrated circuit device 1400 may be formed on a die substrate 1402 (e.g., the wafer 1300 of FIG. 13) and may be included in a die (e.g., the die 1302 of FIG. 13). The die substrate 1402 may be a semiconductor substrate composed of semiconductor material systems including, for example, n-type or p-type materials systems (or a combination of both). The die substrate 1402 may include, for example, a crystalline substrate formed using a bulk silicon or a silicon-on-insulator (SOI) substructure. In some embodiments, the die substrate 1402 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 1402. Although a few examples of materials from which the die substrate 1402 may be formed are described here, any material that may serve as a foundation for an integrated circuit device 1400 may be used. The die substrate 1402 may be part of a singulated die (e.g., the dies 1302 of FIG. 13) or a wafer (e.g., the wafer 1300 of FIG. 13).

The integrated circuit device 1400 may include one or more device layers 1404 disposed on the die substrate 1402. The device layer 1404 may include features of one or more transistors 1440 (e.g., metal oxide semiconductor field-effect transistors (MOSFETs)) formed on the die substrate 1402. The transistors 1440 may include, for example, one or more source and/or drain (S/D) regions 1420, a gate 1422 to control current flow between the S/D regions 1420, and one or more S/D contacts 1424 to route electrical signals to/from the S/D regions 1420. The transistors 1440 may include additional features not depicted for the sake of clarity, such as device isolation regions, gate contacts, and the like. The transistors 1440 are not limited to the type and configuration depicted in FIG. 14 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

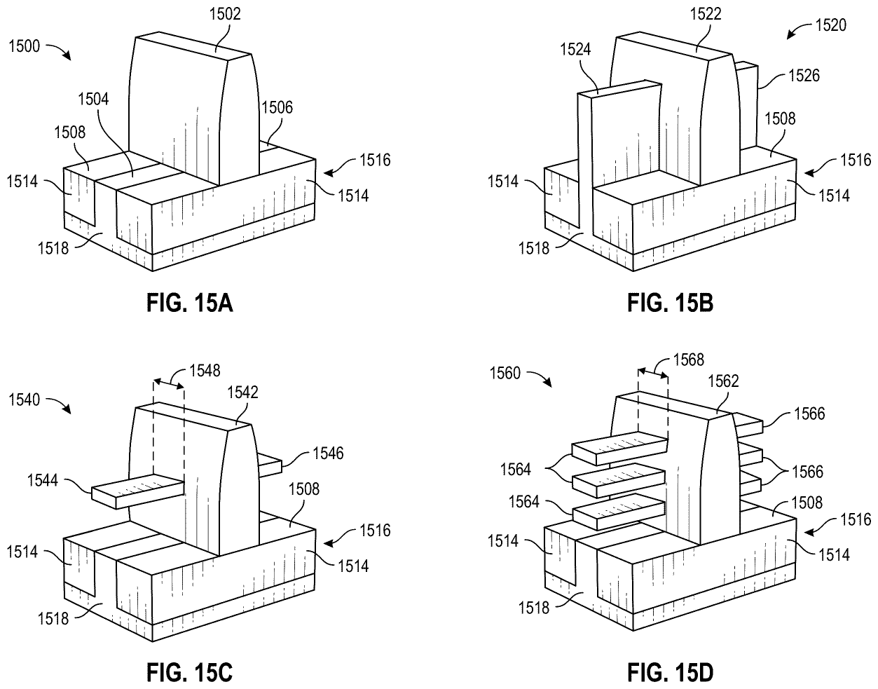

FIGS. 15A-15D are simplified perspective views of example planar, FinFET, gate-all-around, and stacked gate-all-around transistors. The transistors illustrated in FIGS. 15A-15D are formed on a substrate 1516 having a surface 1508. Isolation regions 1514 separate the source and drain regions of the transistors from other transistors and from a bulk region 1518 of the substrate 1516.

FIG. 15A is a perspective view of an example planar transistor 1500 comprising a gate 1502 that controls current flow between a source region 1504 and a drain region 1506. The transistor 1500 is planar in that the source region 1504 and the drain region 1506 are planar with respect to the substrate surface 1508.

FIG. 15B is a perspective view of an example FinFET transistor 1520 comprising a gate 1522 that controls current flow between a source region 1524 and a drain region 1526. The transistor 1520 is non-planar in that the source region 1524 and the drain region 1526 comprise “fins” that extend upwards from the substrate surface 1528. As the gate 1522 encompasses three sides of the semiconductor fin that extends from the source region 1524 to the drain region 1526, the transistor 1520 can be considered a tri-gate transistor. FIG. 15B illustrates one S/D fin extending through the gate 1522, but multiple S/D fins can extend through the gate of a FinFET transistor.

FIG. 15C is a perspective view of a gate-all-around (GAA) transistor 1540 comprising a gate 1542 that controls current flow between a source region 1544 and a drain region 1546. The transistor 1540 is non-planar in that the source region 1544 and the drain region 1546 are elevated from the substrate surface 1528.

FIG. 15D is a perspective view of a GAA transistor 1560 comprising a gate 1562 that controls current flow between multiple elevated source regions 1564 and multiple elevated drain regions 1566. The transistor 1560 is a stacked GAA transistor as the gate controls the flow of current between multiple elevated S/D regions stacked on top of each other. The transistors 1540 and 1560 are considered gate-all-around transistors as the gates encompass all sides of the semiconductor portions that extends from the source regions to the drain regions. The transistors 1540 and 1560 can alternatively be referred to as nanowire, nanosheet, or nanoribbon transistors depending on the width (e.g., widths 1548 and 1568 of transistors 1540 and 1560, respectively) of the semiconductor portions extending through the gate.

Returning to FIG. 14, a transistor 1440 may include a gate 1422 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 1440 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 1440 along the source-channel-drain direction, the gate electrode may consist of a U-shaped structure that includes a bottom portion substantially parallel to the surface of the die substrate 1402 and two sidewall portions that are substantially perpendicular to the top surface of the die substrate 1402. In other embodiments, at least one of the metal layers that form the gate electrode may simply be a planar layer that is substantially parallel to the top surface of the die substrate 1402 and does not include sidewall portions substantially perpendicular to the top surface of the die substrate 1402. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 1420 may be formed within the die substrate 1402 adjacent to the gate 1422 of individual transistors 1440. The S/D regions 1420 may be formed using an implantation/diffusion process or an etching/deposition process, for example. In the former process, dopants such as boron, aluminum, antimony, phosphorous, or arsenic may be ion-implanted into the die substrate 1402 to form the S/D regions 1420. An annealing process that activates the dopants and causes them to diffuse farther into the die substrate 1402 may follow the ion-implantation process. In the latter process, the die substrate 1402 may first be etched to form recesses at the locations of the S/D regions 1420. An epitaxial deposition process may then be carried out to fill the recesses with material that is used to fabricate the S/D regions 1420. In some implementations, the S/D regions 1420 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 1420 may be formed using one or more alternate semiconductor materials such as germanium or a group III-V material or alloy. In further embodiments, one or more layers of metal and/or metal alloys may be used to form the S/D regions 1420.

Electrical signals, such as power and/or input/output (I/O) signals, may be routed to and/or from the devices (e.g., transistors 1440) of the device layer 1404 through one or more interconnect layers disposed on the device layer 1404 (illustrated in FIG. 14 as interconnect layers 1406-1410). For example, electrically conductive features of the device layer 1404 (e.g., the gate 1422 and the S/D contacts 1424) may be electrically coupled with the interconnect structures 1428 of the interconnect layers 1406-1410. The one or more interconnect layers 1406-1410 may form a metallization stack (also referred to as an “ILD stack”) 1419 of the integrated circuit device 1400.

The interconnect structures 1428 may be arranged within the interconnect layers 1406-1410 to route electrical signals according to a wide variety of designs; in particular, the arrangement is not limited to the particular configuration of interconnect structures 1428 depicted in FIG. 14. Although a particular number of interconnect layers 1406-1410 is depicted in FIG. 14, embodiments of the present disclosure include integrated circuit devices having more or fewer interconnect layers than depicted.

In some embodiments, the interconnect structures 1428 may include lines 1428a and/or vias 1428b filled with an electrically conductive material such as a metal. The lines 1428a may be arranged to route electrical signals in a direction of a plane that is substantially parallel with a surface of the die substrate 1402 upon which the device layer 1404 is formed. For example, the lines 1428a may route electrical signals in a direction in and out of the page and/or in a direction across the page. The vias 1428b may be arranged to route electrical signals in a direction of a plane that is substantially perpendicular to the surface of the die substrate 1402 upon which the device layer 1404 is formed. In some embodiments, the vias 1428b may electrically couple lines 1428a of different interconnect layers 1406-1410 together.

The interconnect layers 1406-1410 may include a dielectric material 1426 disposed between the interconnect structures 1428, as shown in FIG. 14. In some embodiments, dielectric material 1426 disposed between the interconnect structures 1428 in different ones of the interconnect layers 1406-1410 may have different compositions; in other embodiments, the composition of the dielectric material 1426 between different interconnect layers 1406-1410 may be the same. The device layer 1404 may include a dielectric material 1426 disposed between the transistors 1440 and a bottom layer of the metallization stack as well. The dielectric material 1426 included in the device layer 1404 may have a different composition than the dielectric material 1426 included in the interconnect layers 1406-1410; in other embodiments, the composition of the dielectric material 1426 in the device layer 1404 may be the same as a dielectric material 1426 included in any one of the interconnect layers 1406-1410.

A first interconnect layer 1406 (referred to as Metal 1 or “M1”) may be formed directly on the device layer 1404. In some embodiments, the first interconnect layer 1406 may include lines 1428a and/or vias 1428b, as shown. The lines 1428a of the first interconnect layer 1406 may be coupled with contacts (e.g., the S/D contacts 1424) of the device layer 1404. The vias 1428b of the first interconnect layer 1406 may be coupled with the lines 1428a of a second interconnect layer 1408.

The second interconnect layer 1408 (referred to as Metal 2 or “M2”) may be formed directly on the first interconnect layer 1406. In some embodiments, the second interconnect layer 1408 may include via 1428b to couple the lines 1428 of the second interconnect layer 1408 with the lines 1428a of a third interconnect layer 1410. Although the lines 1428a and the vias 1428b are structurally delineated with a line within individual interconnect layers for the sake of clarity, the lines 1428a and the vias 1428b may be structurally and/or materially contiguous (e.g., simultaneously filled during a dual-damascene process) in some embodiments.

The third interconnect layer 1410 (referred to as Metal 3 or “M3”) (and additional interconnect layers, as desired) may be formed in succession on the second interconnect layer 1408 according to similar techniques and configurations described in connection with the second interconnect layer 1408 or the first interconnect layer 1406. In some embodiments, the interconnect layers that are “higher up” in the metallization stack 1419 in the integrated circuit device 1400 (i.e., farther away from the device layer 1404) may be thicker that the interconnect layers that are lower in the metallization stack 1419, with lines 1428a and vias 1428b in the higher interconnect layers being thicker than those in the lower interconnect layers.

The integrated circuit device 1400 may include a solder resist material 1434 (e.g., polyimide or similar material) and one or more conductive contacts 1436 formed on the interconnect layers 1406-1410. In FIG. 14, the conductive contacts 1436 are illustrated as taking the form of bond pads. The conductive contacts 1436 may be electrically coupled with the interconnect structures 1428 and configured to route the electrical signals of the transistor(s) 1440 to external devices. For example, solder bonds may be formed on the one or more conductive contacts 1436 to mechanically and/or electrically couple an integrated circuit die including the integrated circuit device 1400 with another component (e.g., a printed circuit board). The integrated circuit device 1400 may include additional or alternate structures to route the electrical signals from the interconnect layers 1406-1410; for example, the conductive contacts 1436 may include other analogous features (e.g., posts) that route the electrical signals to external components. The conductive contacts 1436 may serve as the conductive contacts 326 or 328, as appropriate.

In some embodiments in which the integrated circuit device 1400 is a double-sided die, the integrated circuit device 1400 may include another metallization stack (not shown) on the opposite side of the device layer(s) 1404. This metallization stack may include multiple interconnect layers as discussed above with reference to the interconnect layers 1406-1410, to provide conductive pathways (e.g., including conductive lines and vias) between the device layer(s) 1404 and additional conductive contacts (not shown) on the opposite side of the integrated circuit device 1400 from the conductive contacts 1436. These additional conductive contacts may serve as the conductive contacts 326 or 328, as appropriate.

In other embodiments in which the integrated circuit device 1400 is a double-sided die, the integrated circuit device 1400 may include one or more through silicon vias (TSVs) through the die substrate 1402; these TSVs may make contact with the device layer(s) 1404, and may provide conductive pathways between the device layer(s) 1404 and additional conductive contacts (not shown) on the opposite side of the integrated circuit device 1400 from the conductive contacts 1436. These additional conductive contacts may serve as the conductive contacts 326 or 328, as appropriate. In some embodiments, TSVs extending through the substrate can be used for routing power and ground signals from conductive contacts on the opposite side of the integrated circuit device 1400 from the conductive contacts 1436 to the transistors 1440 and any other components integrated into the die 1400, and the metallization stack 1419 can be used to route I/O signals from the conductive contacts 1436 to transistors 1440 and any other components integrated into the die 1400.

Multiple integrated circuit devices 1400 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

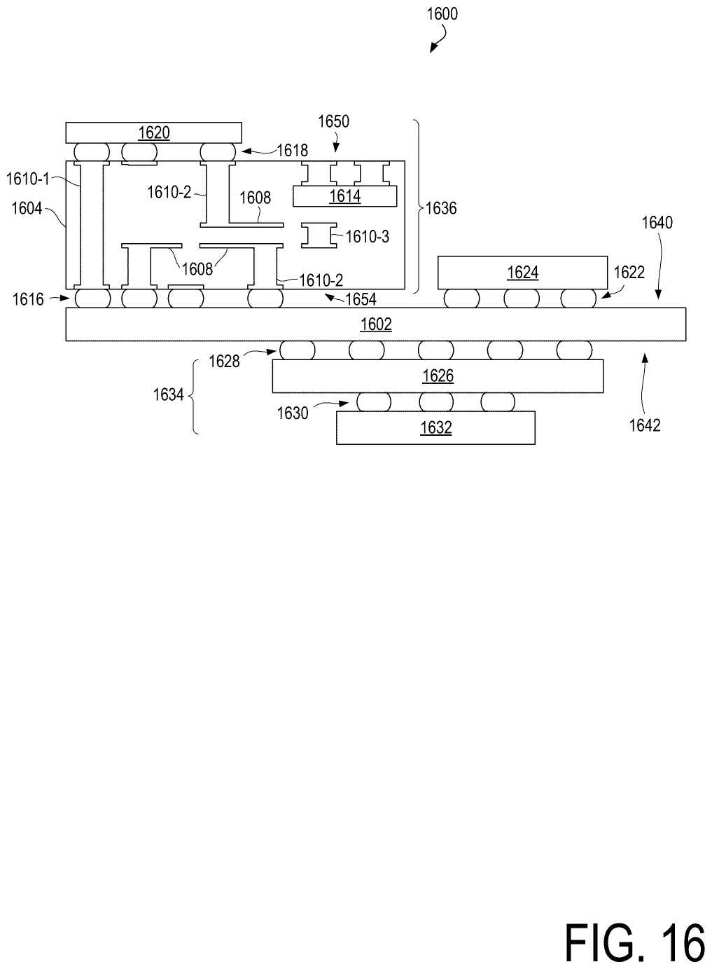

FIG. 16 is a cross-sectional side view of an integrated circuit device assembly 1600 that may include any of the integrated circuit packages 100 disclosed herein. In some embodiments, the integrated circuit device assembly 1600 may be an integrated circuit packages 100. The integrated circuit device assembly 1600 includes a number of components disposed on a circuit board 1602 (which may be a motherboard, system board, mainboard, etc.). The integrated circuit device assembly 1600 includes components disposed on a first face 1640 of the circuit board 1602 and an opposing second face 1642 of the circuit board 1602; generally, components may be disposed on one or both faces 1640 and 1642. Any of the integrated circuit components discussed below with reference to the integrated circuit device assembly 1600 may take the form of any suitable ones of the embodiments of the integrated circuit packages 100 disclosed herein.

In some embodiments, the circuit board 1602 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1602. In other embodiments, the circuit board 1602 may be a non-PCB substrate. In some embodiments the circuit board 1602 may be, for example, the circuit board 102. The integrated circuit device assembly 1600 illustrated in FIG. 16 includes a package-on-interposer structure 1636 coupled to the first face 1640 of the circuit board 1602 by coupling components 1616. The coupling components 1616 may electrically and mechanically couple the package-on-interposer structure 1636 to the circuit board 1602, and may include solder balls (as shown in FIG. 16), pins (e.g., as part of a pin grid array (PGA), contacts (e.g., as part of a land grid array (LGA)), male and female portions of a socket, an adhesive, an underfill material, and/or any other suitable electrical and/or mechanical coupling structure. The coupling components 1616 may serve as the coupling components illustrated or described for any of the substrate assembly or substrate assembly components described herein, as appropriate.

The package-on-interposer structure 1636 may include an integrated circuit component 1620 coupled to an interposer 1604 by coupling components 1618. The coupling components 1618 may take any suitable form for the application, such as the forms discussed above with reference to the coupling components 1616. Although a single integrated circuit component 1620 is shown in FIG. 16, multiple integrated circuit components may be coupled to the interposer 1604; indeed, additional interposers may be coupled to the interposer 1604. The interposer 1604 may provide an intervening substrate used to bridge the circuit board 1602 and the integrated circuit component 1620.

The integrated circuit component 1620 may be a packaged or unpacked integrated circuit product that includes one or more integrated circuit dies (e.g., the die 1302 of FIG. 13, the integrated circuit device 1400 of FIG. 14) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 1620, a single monolithic integrated circuit die comprises solder bumps attached to contacts on the die. The solder bumps allow the die to be directly attached to the interposer 1604. The integrated circuit component 1620 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 1620 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 1620 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 1620 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 1604 may spread connections to a wider pitch or reroute a connection to a different connection. For example, the interposer 1604 may couple the integrated circuit component 1620 to a set of ball grid array (BGA) conductive contacts of the coupling components 1616 for coupling to the circuit board 1602. In the embodiment illustrated in FIG. 16, the integrated circuit component 1620 and the circuit board 1602 are attached to opposing sides of the interposer 1604; in other embodiments, the integrated circuit component 1620 and the circuit board 1602 may be attached to a same side of the interposer 1604. In some embodiments, three or more components may be interconnected by way of the interposer 1604.

In some embodiments, the interposer 1604 may be formed as a PCB, including multiple metal layers separated from one another by layers of dielectric material and interconnected by electrically conductive vias. In some embodiments, the interposer 1604 may be formed of an epoxy resin, a fiberglass-reinforced epoxy resin, an epoxy resin with inorganic fillers, a ceramic material, or a polymer material such as polyimide. In some embodiments, the interposer 1604 may be formed of alternate rigid or flexible materials that may include the same materials described above for use in a semiconductor substrate, such as silicon, germanium, and other group III-V and group IV materials. The interposer 1604 may include metal interconnects 1608 and vias 1610, including but not limited to through hole vias 1610-1 (that extend from a first face 1650 of the interposer 1604 to a second face 1654 of the interposer 1604), blind vias 1610-2 (that extend from the first or second faces 1650 or 1654 of the interposer 1604 to an internal metal layer), and buried vias 1610-3 (that connect internal metal layers).

In some embodiments, the interposer 1604 can comprise a silicon interposer. Through silicon vias (TSV) extending through the silicon interposer can connect connections on a first face of a silicon interposer to an opposing second face of the silicon interposer. In some embodiments, an interposer 1604 comprising a silicon interposer can further comprise one or more routing layers to route connections on a first face of the interposer 1604 to an opposing second face of the interposer 1604.

The interposer 1604 may further include embedded devices 1614, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1604. The package-on-interposer structure 1636 may take the form of any of the package-on-interposer structures known in the art.

The integrated circuit device assembly 1600 may include an integrated circuit component 1624 coupled to the first face 1640 of the circuit board 1602 by coupling components 1622. The coupling components 1622 may take the form of any of the embodiments discussed above with reference to the coupling components 1616, and the integrated circuit component 1624 may take the form of any of the embodiments discussed above with reference to the integrated circuit component 1620.

The integrated circuit device assembly 1600 illustrated in FIG. 16 includes a package-on-package structure 1634 coupled to the second face 1642 of the circuit board 1602 by coupling components 1628. The package-on-package structure 1634 may include an integrated circuit component 1626 and an integrated circuit component 1632 coupled together by coupling components 1630 such that the integrated circuit component 1626 is disposed between the circuit board 1602 and the integrated circuit component 1632. The coupling components 1628 and 1630 may take the form of any of the embodiments of the coupling components 1616 discussed above, and the integrated circuit components 1626 and 1632 may take the form of any of the embodiments of the integrated circuit component 1620 discussed above. The package-on-package structure 1634 may be configured in accordance with any of the package-on-package structures known in the art.

FIG. 17 is a block diagram of an example electrical device 1700 that may include one or more of the integrated circuit packages 100 disclosed herein. For example, any suitable ones of the components of the electrical device 1700 may include one or more of the integrated circuit device assemblies 1600, integrated circuit components 1620, integrated circuit devices 1400, or integrated circuit dies 1302 disclosed herein, and may be arranged in any of the integrated circuit packages 100 disclosed herein. A number of components are illustrated in FIG. 17 as included in the electrical device 1700, but any one or more of these components may be omitted or duplicated, as suitable for the application. In some embodiments, some or all of the components included in the electrical device 1700 may be attached to one or more motherboards mainboards, or system boards. In some embodiments, one or more of these components are fabricated onto a single system-on-a-chip (SoC) die.

Additionally, in various embodiments, the electrical device 1700 may not include one or more of the components illustrated in FIG. 17, but the electrical device 1700 may include interface circuitry for coupling to the one or more components. For example, the electrical device 1700 may not include a display device 1706, but may include display device interface circuitry (e.g., a connector and driver circuitry) to which a display device 1706 may be coupled. In another set of examples, the electrical device 1700 may not include an audio input device 1724 or an audio output device 1708, but may include audio input or output device interface circuitry (e.g., connectors and supporting circuitry) to which an audio input device 1724 or audio output device 1708 may be coupled.

The electrical device 1700 may include one or more processor units 1702 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1702 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 1700 may include a memory 1704, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1704 may include memory that is located on the same integrated circuit die as the processor unit 1702. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 1700 can comprise one or more processor units 1702 that are heterogeneous or asymmetric to another processor unit 1702 in the electrical device 1700. There can be a variety of differences between the processing units 1702 in a system in terms of a spectrum of metrics of merit including architectural, microarchitectural, thermal, power consumption characteristics, and the like. These differences can effectively manifest themselves as asymmetry and heterogeneity among the processor units 1702 in the electrical device 1700.

In some embodiments, the electrical device 1700 may include a communication component 1712 (e.g., one or more communication components). For example, the communication component 1712 can manage wireless communications for the transfer of data to and from the electrical device 1700. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1712 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1712 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1712 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1712 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1712 may operate in accordance with other wireless protocols in other embodiments. The electrical device 1700 may include an antenna 1722 to facilitate wireless communications and/or to receive other wireless communications (such as AM or FM radio transmissions).

In some embodiments, the communication component 1712 may manage wired communications, such as electrical, optical, or any other suitable communication protocols (e.g., IEEE 802.3 Ethernet standards). As noted above, the communication component 1712 may include multiple communication components. For instance, a first communication component 1712 may be dedicated to shorter-range wireless communications such as Wi-Fi or Bluetooth, and a second communication component 1712 may be dedicated to longer-range wireless communications such as global positioning system (GPS), EDGE, GPRS, CDMA, WiMAX, LTE, EV-DO, or others. In some embodiments, a first communication component 1712 may be dedicated to wireless communications, and a second communication component 1712 may be dedicated to wired communications.

The electrical device 1700 may include battery/power circuitry 1714. The battery/power circuitry 1714 may include one or more energy storage devices (e.g., batteries or capacitors) and/or circuitry for coupling components of the electrical device 1700 to an energy source separate from the electrical device 1700 (e.g., AC line power).

The electrical device 1700 may include a display device 1706 (or corresponding interface circuitry, as discussed above). The display device 1706 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1700 may include an audio output device 1708 (or corresponding interface circuitry, as discussed above). The audio output device 1708 may include any embedded or wired or wirelessly connected external device that generates an audible indicator, such as speakers, headsets, or earbuds.

The electrical device 1700 may include an audio input device 1724 (or corresponding interface circuitry, as discussed above). The audio input device 1724 may include any embedded or wired or wirelessly connected device that generates a signal representative of a sound, such as microphones, microphone arrays, or digital instruments (e.g., instruments having a musical instrument digital interface (MIDI) output). The electrical device 1700 may include a Global Navigation Satellite System (GNSS) device 1718 (or corresponding interface circuitry, as discussed above), such as a Global Positioning System (GPS) device. The GNSS device 1718 may be in communication with a satellite-based system and may determine a geolocation of the electrical device 1700 based on information received from one or more GNSS satellites, as known in the art.

The electrical device 1700 may include an other output device 1710 (or corresponding interface circuitry, as discussed above). Examples of the other output device 1710 may include an audio codec, a video codec, a printer, a wired or wireless transmitter for providing information to other devices, or an additional storage device.

The electrical device 1700 may include an other input device 1720 (or corresponding interface circuitry, as discussed above). Examples of the other input device 1720 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1700 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1700 may be any other electronic device that processes data. In some embodiments, the electrical device 1700 may comprise multiple discrete physical components. Given the range of devices that the electrical device 1700 can be manifested as in various embodiments, in some embodiments, the electrical device 1700 can be referred to as a computing device or a computing system.

### EXAMPLES

Illustrative examples of the technologies disclosed herein are provided below. An embodiment of the technologies may include any one or more, and any combination of, the examples described below.

Example 1 includes an apparatus comprising a photonic integrated circuit (PIC) die comprising a first set of one or more waveguides; and a glass substrate comprising a second set of one or more waveguides, wherein individual waveguides of the second set of one or more waveguides are direct-write waveguides; and a third set of one or more waveguides, wherein individual waveguides of the third set of one or more waveguides have a cladding, wherein the cladding of individual waveguides of the third set of one or more waveguides are a different material from the corresponding waveguide, wherein individual waveguides of the second set of one or more waveguides are coupled to individual waveguides of the first set of one or more waveguides and coupled to individual waveguides of the third set of one or more waveguides.

Example 2 includes the subject matter of Example 1, and further including a second PIC die, the second PIC die comprising a fourth set of one or more waveguides, wherein the glass substrate comprises a fifth set of one or more waveguides, wherein individual waveguides of the fifth set of one or more waveguides are coupled to individual waveguides of the fourth set of one or more waveguides and coupled to individual waveguides of the third set of one or more waveguides, wherein the second, third, and fifth sets of one or more waveguides in the glass substrate couple the first set of one or more waveguides to the fourth set of one or more waveguides.

Example 3 includes the subject matter of any of Examples 1 and 2, and further including a first set of one or more micromirrors and a second set of micromirrors, wherein individual micromirrors of the first set of one or more micromirrors are to collimate light from one of the first set of one or more waveguides and direct the collimated light towards one of the second set of micromirrors, wherein individual micromirrors of the second set of one or more micromirrors are to focus light from one of the first set of one or more micromirrors into one of the second set of one or more waveguides.

Example 4 includes the subject matter of any of Examples 1-3, and wherein individual waveguides of the third set of one or more waveguides comprise silicon and nitrogen.

Example 5 includes the subject matter of any of Examples 1-4, and wherein individual waveguides of the second set of one or more waveguides comprise silicon and oxygen.

Example 6 includes the subject matter of any of Examples 1-5, and wherein, at a coupling interface, the first set of one or more waveguides and the second set of one or more waveguides are arranged in a two-dimensional multirow interconnect interface.

Example 7 includes the subject matter of any of Examples 1-6, and wherein the third set of one or more waveguides are arranged in two or more layers in the glass substrate.

Example 8 includes the subject matter of any of Examples 1-7, and wherein an optical connector for an optical fiber is defined at an edge of the glass substrate.

Example 9 includes the subject matter of any of Examples 1-8, and further including a set of one or more polymer waveguides defined in a polymer cladding, wherein individual polymer waveguides of the set of one or more polymer waveguides extend from a waveguide of the first set of one or more waveguides to a waveguide of the second set of one or more waveguides.

Example 10 includes the subject matter of any of Examples 1-9, and wherein individual waveguides of the first set of one or more waveguides are butt-coupled to individual waveguides of the second set of one or more waveguides.

Example 11 includes the subject matter of any of Examples 1-10, and further including one or more optical components adjacent the glass substrate coupled to the third set of one or more waveguides.

Example 12 includes the subject matter of any of Examples 1-11, and wherein the one or more optical components comprise one or more active optical components.

Example 13 includes the subject matter of any of Examples 1-12, and wherein the one or more optical components comprise one or more passive optical components.

Example 14 includes the subject matter of any of Examples 1-13, and wherein the one or more passive optical components comprise a cyclical arrayed waveguide grating.

Example 15 includes an integrated circuit package comprising the apparatus of Example 1 and an electrical integrated circuit (EIC) die, wherein the EIC die is mated to the PIC die.

Example 16 includes the subject matter of Example 15, and wherein the glass substrate is a glass interposer for the integrated circuit package, wherein the glass substrate comprises a plurality of through-glass vias.

Example 17 includes an apparatus comprising a photonic integrated circuit (PIC) die comprising a first set of one or more waveguides; a glass substrate comprising a second set of one or more waveguides, wherein individual waveguides of the second set of one or more waveguides have a difference between a core index of refraction and a cladding index of refraction that is less than 0.01; and a third set of one or more waveguides, wherein individual waveguides of the second set of one or more waveguides have a difference between a core index of refraction and a cladding index of refraction that is more than 0.1, wherein individual waveguides of the second set of one or more waveguides are coupled to individual waveguides of the first set of one or more waveguides and coupled to individual waveguides of the third set of one or more waveguides.

Example 18 includes the subject matter of Example 17, and further including a second PIC die, the second PIC die comprising a fourth set of one or more waveguides, wherein the glass substrate comprises a fifth set of one or more waveguides, wherein individual waveguides of the fifth set of one or more waveguides are coupled to individual waveguides of the fourth set of one or more waveguides and coupled to individual waveguides of the third set of one or more waveguides, wherein the second, third, and fifth sets of one or more waveguides in the glass substrate couple the first set of one or more waveguides to the fourth set of one or more waveguides.

Example 19 includes the subject matter of any of Examples 17 and 18, and further including a first set of one or more micromirrors and a second set of micromirrors, wherein individual micromirrors of the first set of one or more micromirrors are to collimate light from one of the first set of one or more waveguides and direct the collimated light towards one of the second set of micromirrors, wherein individual micromirrors of the second set of one or more micromirrors are to focus light from one of the first set of one or more micromirrors into one of the second set of one or more waveguides.

Example 20 includes the subject matter of any of Examples 17-19, and wherein individual waveguides of the third set of one or more waveguides comprise silicon and nitrogen.

Example 21 includes the subject matter of any of Examples 17-20, and wherein individual waveguides of the second set of one or more waveguides comprise silicon and oxygen.

Example 22 includes the subject matter of any of Examples 17-21, and wherein, at a coupling interface, the first set of one or more waveguides and the second set of one or more waveguides are arranged in a two-dimensional multirow interconnect interface.

Example 23 includes the subject matter of any of Examples 17-22, and wherein the third set of one or more waveguides are arranged in two or more layers in the glass substrate.

Example 24 includes the subject matter of any of Examples 17-23, and wherein an optical connector for an optical fiber is defined at an edge of the glass substrate.

Example 25 includes the subject matter of any of Examples 17-24, and further including a set of one or more polymer waveguides defined in a polymer cladding, wherein individual polymer waveguides of the set of one or more polymer waveguides extend from a waveguide of the first set of one or more waveguides to a waveguide of the second set of one or more waveguides.

Example 26 includes the subject matter of any of Examples 17-25, and wherein individual waveguides of the first set of one or more waveguides are butt-coupled to individual waveguides of the second set of one or more waveguides.

Example 27 includes the subject matter of any of Examples 17-26, and further including one or more optical components adjacent the glass substrate coupled to the third set of one or more waveguides.

Example 28 includes the subject matter of any of Examples 17-27, and wherein the one or more optical components comprise one or more active optical components.

Example 29 includes the subject matter of any of Examples 17-28, and wherein the one or more optical components comprise one or more passive optical components.

Example 30 includes the subject matter of any of Examples 17-29, and wherein the one or more passive optical components comprise a cyclical arrayed waveguide grating.

Example 31 includes an integrated circuit package comprising the apparatus of Example 17 and an electrical integrated circuit (EIC) die, wherein the EIC die is mated to the PIC die.

Example 32 includes the subject matter of Example 31, and wherein the glass substrate is a glass interposer for the integrated circuit package, wherein the glass substrate comprises a plurality of through-glass vias.

Example 33 includes an apparatus comprising a glass substrate comprising a bulk layer; a cladding layer adjacent the bulk layer; a first set of one or more waveguides, wherein the cladding layer provides at least part of a cladding for the first set of one or more waveguides; and a second set of one or more waveguides defined in the bulk layer.

Example 34 includes the subject matter of Example 33, and wherein individual waveguides of the second set of one or more waveguides have a core and a cladding, wherein the core and the cladding for individual waveguides of the second set of one or more waveguides are the same material.

Example 35 includes the subject matter of any of Examples 33 and 34, and further including a photonic integrated circuit (PIC) die, the PIC die comprising a third set of one or more waveguides, wherein individual waveguides of the first set of one or more waveguides are coupled to individual waveguides of the second set of one or more waveguides and coupled to individual waveguides of the third set of one or more waveguides.

Example 36 includes the subject matter of any of Examples 33-35, and wherein individual waveguides of the second set of one or more waveguides comprise silicon and nitrogen.

Example 37 includes the subject matter of any of Examples 33-36, and wherein individual waveguides of the first set of one or more waveguides comprise silicon and oxygen.

1. An apparatus comprising:
a photonic integrated circuit (PIC) die comprising a first set of one or more waveguides; and
a glass substrate comprising:
a second set of one or more waveguides, wherein individual waveguides of the second set of one or more waveguides are direct-write waveguides; and
a third set of one or more waveguides, wherein individual waveguides of the third set of one or more waveguides have a cladding, wherein the cladding of individual waveguides of the third set of one or more waveguides are a different material from the corresponding waveguide,
wherein individual waveguides of the second set of one or more waveguides are coupled to individual waveguides of the first set of one or more waveguides and coupled to individual waveguides of the third set of one or more waveguides.

2. The apparatus of claim 1, further comprising a second PIC die, the second PIC die comprising a fourth set of one or more waveguides,
wherein the glass substrate comprises a fifth set of one or more waveguides,
wherein individual waveguides of the fifth set of one or more waveguides are coupled to individual waveguides of the fourth set of one or more waveguides and coupled to individual waveguides of the third set of one or more waveguides,
wherein the second, third, and fifth sets of one or more waveguides in the glass substrate couple the first set of one or more waveguides to the fourth set of one or more waveguides.

3. The apparatus of claim 1, further comprising a first set of one or more micromirrors and a second set of micromirrors, wherein individual micromirrors of the first set of one or more micromirrors are to collimate light from one of the first set of one or more waveguides and direct the collimated light towards one of the second set of micromirrors, wherein individual micromirrors of the second set of one or more micromirrors are to focus light from one of the first set of one or more micromirrors into one of the second set of one or more waveguides.

4. The apparatus of claim 1, wherein individual waveguides of the third set of one or more waveguides comprise silicon and nitrogen.

5. The apparatus of claim 4, wherein individual waveguides of the second set of one or more waveguides comprise silicon and oxygen.

6. The apparatus of claim 1, wherein, at a coupling interface, the first set of one or more waveguides and the second set of one or more waveguides are arranged in a two-dimensional multirow interconnect interface.

7. The apparatus of claim 1, wherein the third set of one or more waveguides are arranged in two or more layers in the glass substrate.

8. The apparatus of claim 1, further comprising one or more optical components adjacent the glass substrate coupled to the third set of one or more waveguides.

9. The apparatus of claim 8, wherein the one or more optical components comprise one or more active optical components.

10. The apparatus of claim 8, wherein the one or more optical components comprise one or more passive optical components.

11. The apparatus of claim 10, wherein the one or more passive optical components comprise a cyclical arrayed waveguide grating.

12. An integrated circuit package comprising the apparatus of claim 1 and an electrical integrated circuit (EIC) die, wherein the EIC die is mated to the PIC die.

13. The integrated circuit package of claim 12, wherein the glass substrate is a glass interposer for the integrated circuit package, wherein the glass substrate comprises a plurality of through-glass vias.

14. An apparatus comprising:
a photonic integrated circuit (PIC) die comprising a first set of one or more waveguides;
a glass substrate comprising:
a second set of one or more waveguides, wherein individual waveguides of the second set of one or more waveguides have a difference between a core index of refraction and a cladding index of refraction that is less than 0.01; and
a third set of one or more waveguides, wherein individual waveguides of the second set of one or more waveguides have a difference between a core index of refraction and a cladding index of refraction that is more than 0.1,
wherein individual waveguides of the second set of one or more waveguides are coupled to individual waveguides of the first set of one or more waveguides and coupled to individual waveguides of the third set of one or more waveguides.

15. The apparatus of claim 14, wherein an optical connector for an optical fiber is defined at an edge of the glass substrate.

16. The apparatus of claim 14, further comprising a set of one or more polymer waveguides defined in a polymer cladding, wherein individual polymer waveguides of the set of one or more polymer waveguides extend from a waveguide of the first set of one or more waveguides to a waveguide of the second set of one or more waveguides.

17. The apparatus of claim 14, wherein individual waveguides of the first set of one or more waveguides are butt-coupled to individual waveguides of the second set of one or more waveguides.

18. An apparatus comprising:
a glass substrate comprising:
a bulk layer;
a cladding layer adjacent the bulk layer;
a first set of one or more waveguides, wherein the cladding layer provides at least part of a cladding for the first set of one or more waveguides; and
a second set of one or more waveguides defined in the bulk layer.

19. The apparatus of claim 18, wherein individual waveguides of the second set of one or more waveguides have a core and a cladding, wherein the core and the cladding for individual waveguides of the second set of one or more waveguides are the same material.

20. The apparatus of claim 18, further comprising a photonic integrated circuit (PIC) die, the PIC die comprising a third set of one or more waveguides,
wherein individual waveguides of the first set of one or more waveguides are coupled to individual waveguides of the second set of one or more waveguides and coupled to individual waveguides of the third set of one or more waveguides.
